(19) United States
(12) Patent Application Publication
(10) Pub. No.: US 2016/0221287 A1
(43) Pub. Date: Aug. 4, 2016

(54) METHOD OF JOINING TWO RUBBER TYRE PORTIONS

(71) Applicants: Salvatore COTUGNO,, Roma (IT); Francesco DELUCA,, Roma (IT); Ludovica CALLANO, Roma (IT); BRIDGESTONE CORPORATION, Chuo-Ku,Tokyo (JP)

(72) Inventors: Salvatore COTUGNO, Roma (IT); Francesco DE LUCA, Roma (IT); Ludovica CALIANO, Roma (IT)

(73) Assignee: BRIDGESTONE CORPORATION, Tokyo (JP)

(21) Appl. No.: 14/916,215

(22) PCT Filed: Sep. 3, 2014
(86) PCT No.: PCT/IB2014/064237

§ 371 Date: Mar. 3, 2016

(30) Foreign Application Priority Data
Sep. 4, 2013 (IT) RM2013A000491

(51) Int. Cl. B29D 30/54; C09J 11/06; C09J 107/00

(52) U.S. Cl. CPC B29D 30/54; C09J 107/00; C09J 11/06; B29D 2030/544

(57) ABSTRACT

A method of joining two rubber tyre portions, the method including applying a water-based adhesive compound to at least one surface of one of the two portions; and joining the two rubber portions. The water-based adhesive compound has water as a solvent, a cross-linkable, unsaturated-chain polymer base, and an emulsifier with a CMC value of 0.1 to 12 mmol/L, and an HLB value of 1 to 45.

### TECHNICAL FIELD

The present invention relates to a method of joining two rubber tyre portions.

### BACKGROUND ART

Adhesive compounds, known as cements, used in tyre manufacturing are normally organic-solvent-based. Adhesive compounds of this sort are highly adhesive and extremely easy to use, mainly due to the ability of rubber to dissolve in organic solvents and so merge with other rubber into practically one piece once the organic solvent evaporates.

For environmental reasons, recent European directives have drastically limited the use of organic solvents in the tyre industry, thus forcing manufacturers to find alternative solutions capable of ensuring firm adhesion of rubber layers.

One solution, considered for some time now, is to use water-based adhesive compounds.

For these to be feasible, it is necessary to ensure dispersion and stability of the various compound ingredients in the water solvent.

This is normally done using emulsifiers capable of dispersing at least some of the compound ingredients. One of the problems of water-based compounds, however, is the large amount of emulsifier often required. In fact, tests show that using large amounts or different types of emulsifiers in water-based adhesive compounds may impair the adhesive power of the compound.

A water-based adhesive compound emulsifier is therefore needed, which can be used in small amounts, while at the same time ensuring adhesion comparable with, if not superior to, corresponding solvent-based adhesive compounds.

The Applicant has surprisingly discovered that emulsifiers with specific chemical/physical characteristics satisfy the above requirements.

Here and hereinafter, CMC is intended to mean the critical micelle concentration value of an emulsifier, measured in water, at 25° C., at atmospheric pressure.

Here and hereinafter, HLB is intended to mean the hydrophilic-hydrophobic balance index of an emulsifier according to equation (I) in “J. T. Davies, A quantitative kinetic theory of emulsion type, I, Physical chemistry of the emulsifying agent. Proceedings of 2nd International Congress Surface/Activity, Butterworths, London 1957”

HLB=7+m*Hh−n*Hl (I)

where:

m is the number of hydrophilic groups in the molecule;

Hh is the hydrophilic group value;

N is the number of lipophilic groups;

Hl is the lipophilic group value.

### DISCLOSURE OF INVENTION

According to the present invention, there is provided a method of joining two rubber tyre portions, the method comprising applying a water-based adhesive compound to at least one surface of one of the two portions; and joining said two rubber portions; said method being characterized in that said water-based adhesive compound comprises water as a solvent, a cross-linkable, unsaturated-chain polymer base, and an emulsifier with a CMC value of 0.1 to 12 mmol/L, and an HLB value of 1 to 45.

Preferably, said emulsifier is of general formula (I):

(R₁COO)ₙⁿ⁻Xⁿ⁺ (I)

where:

R₁ is a straight or branched aliphatic hydrocarbon chain containing 10 to 25 carbon atoms and at least one unsaturation;

n is 1 or 2; and

X is a metal cation.

Preferably, the emulsifier of general formula (I) has a CMC value of 0.1 to 2 mmol/L, and an HLB value of 1 to 20.

Preferably, said emulsifier is sodium oleate. Preferably, said emulsifier is of general formula (II):

(R1SO₃)ₙⁿ⁻¹Xⁿ⁺ (II)

where:

R₁ is a straight or branched aliphatic hydrocarbon chain containing 10 to 25 carbon atoms and at least one unsaturation;

n is 1 or 2; and

X is a metal cation.

Preferably, the emulsifier of general formula (II) has a CMC value of 0.1 to 2 mmol/L, and an HLB value of 21 to 45.

Preferably, said emulsifier is sodium dodecylbenzenesulphonate or sodium lignosulphonate.

Preferably, the adhesive compound contains 0.1 to 5 phr of said emulsifier.

Preferably, the water-based adhesive compound comprises an alkylphenol formaldehyde resin of the general formula:

R₁CONR₂CHR₃COOX

where:

R₁ is an aliphatic hydrocarbon group C₆-C₂₃;

R₂ is H or an aliphatic hydrocarbon group C₁-C₈;

R₃ is H or an aliphatic or aromatic hydrocarbon group C₁-C₈; and

X is a cation.

Preferably, the alkylphenol making up the resin is p-phenol-2-pentyl-2,4,4-trimethyl.

### BEST MODE FOR CARRYING OUT THE INVENTION

The following are non-limiting examples for a clearer understanding of the invention.

### EXAMPLES

Three water-based adhesive compounds according to the present invention (A, B, C), and differing as to the emulsifier used, were prepared.

Water-based compounds A-C were prepared by simultaneously dispersing all the ingredients shown in enough water to disperse them homogenously. The resulting aqueous solution was agitated mechanically for 30 minutes and then sonicated for 15 minutes to obtain an aqueous dispersion.

The above process of producing the aqueous dispersions in no way constitutes a limitation of the present invention.

For comparison purposes, a solvent-based adhesive compound (D) was produced comprising the same composition in phr as the above compounds, except for, obviously, the emulsifiers.

Table I shows the compositions of adhesive compounds A-D and the water or organic solvent weight percentages.

TABLE I

| | | A | B | C | D |
|---|---|---|---|---|---|
| solvent % | | 55 | 55 | 55 | 30 |
| | | water | water | water | n-heptane |
| Composition | Natural rubber | 100 | | | |
| in phr | Resin | 20 | | | |
| | Carbon black | 10 | | | |
| | ZnO | 3 | | | |
| | Sulphur | 2.7 | | | |
| | Accelerant | 1.4 | | | |
| | Emulsifier (a) | 1.1 | — | — | — |
| | Emulsifier (b) | — | 1.1 | — | — |
| | Emulsifier (c) | — | — | 1.1 | — |

Emulsifier (a) is sodium oleate.

Emulsifier (b) is sodium dodecylbenzenesulphonate.

Emulsifier (c) is sodium lignosulphonate.

The resin used is in the alkylphenol-formaldehyde class marketed by the SI Group company under the trade name HRJ-16231, and in which the alkylphenol making up the resin is p-phenol-2-pentyl-2,4,4-trimethyl.

The accelerant used is MBTS.

Another three water-based adhesive compounds (E, F, G) were prepared according to the present invention and using the same procedure as indicated above for compounds A-C, but differing from compounds A-C mainly by having no curing system.

Table II shows the compositions of adhesive compounds E-G and the water weight percentages.

TABLE II

| | E | F | G |
|---|---|---|---|
| solvent % | 55 | 55 | 55 |
| | water | water | water |

| | | |
|---|---|---|
| Composition | Natural Rubber | 100 |
| in phr | Resin | 10 |
| | Carbon Black | 2 |
| | ZnO | — |
| | Sulphur | — |
| | Accelerant | — |

| | | | |
|---|---|---|---|
| Emulsifier (a) | 0.19 | — | — |
| Emulsifier (b) | — | 0.19 | — |
| Emulsifier (c) | — | — | 0.19 |

In addition to natural rubber, the adhesive compounds according to the present invention may comprise any cross-linkable-chain polymer base obtained by polymerization of conjugate dienes and/or aliphatic or aromatic vinyl monomers. For example, the polymer bases that may be used are selected from the group comprising natural rubber; 1,4-cis polyisoprene; polybutadiene; isoprene-isobutene copolymers, possibly halogenated; butadiene-acrylonitrile copolymers; styrene-butadiene copolymers; styrene-butadiene-isoprene terpolymers, in solution or emulsion; and ethylene-propylene-diene terpolymers. The above polymer bases may be used on their own or mixed.

Laboratory tests

Adhesive compounds A-G were all adhesion tested under the same test conditions. More specifically, each adhesive compound was used to join a rubber tyre-retread portion to a rubber portion of the tyre for retreading.

Each compound was applied to one surface of one of the portions to be joined, and allowed to dry before joining the two portions.

More specifically, 25° C. grip of a green tyre-retread portion to the cured portion of the tyre for retreading was tack tested to determine the characteristics of the tyre being retreaded; and grip of a cured tyre-retread portion to the cured portion of the retreaded tyre was peel tested to determine the characteristics of the end product, i.e. the retreaded tyre.

The adhesion test results are shown in Tables III and IV.

TABLE III

| | A | B | C | D |
|---|---|---|---|---|
| Tack (gr) | 1613 | 1159 | 904 | 1131 |
| Peeling (N/mm) | 23.1 | 15.6 | 17.6 | 30.55 |

TABLE IV

| | E | F | G |
|---|---|---|---|
| Tack (gr) | 1791 | 1368 | 1539 |
| Peeling (N/mm) | 18.6 | 20.5 | 20.7 |

Tables III and IV clearly show the comparable or superior adhesive power of the water-based adhesive compounds according to the invention with respect to the solvent-based control adhesive compound.

In other words, using emulsifiers with specific chemical/physical characteristics, the water-based adhesive compounds according to the invention provide for joining rubber portions as effectively as, if not better than, corresponding solvent-based adhesive compounds.

1. A method of joining two rubber tyre portions, the method comprising applying a water-based adhesive compound to at least one surface of one of the two portions; and joining said two rubber portions; said method being characterized in that said water-based adhesive compound comprises water as a solvent, a cross-linkable, unsaturated-chain polymer base, and an emulsifier with a CMC value of 0.1 to 12 mmol/L, and an HLB value of 1 to 45.

2. A method of joining two rubber tyre portions, as claimed in claim 1, characterized in that said emulsifier is of the general formula:
(R₁COO)ₙⁿ⁻Xⁿ⁺
where:
R₁ is a straight or branched aliphatic hydrocarbon chain containing 10 to 25 carbon atoms and at least one unsaturation;
n is 1 or 2; and
X is a metal cation.

3. A method of joining two rubber tyre portions, as claimed in claim 2, characterized in that said emulsifier has a CMC value of 0.1 to 2 mmol/L, and an HLB value of 1 to 20.

4. A method of joining two rubber tyre portions, as claimed in claim 3, characterized in that said emulsifier is sodium oleate.

5. A method of joining two rubber tyre portions, as claimed in claim 1, characterized in that said emulsifier is of the general formula:
(R1SO₃)ₙⁿ⁻¹Xⁿ⁺
where:
R₁ is a straight or branched aliphatic hydrocarbon chain containing 10 to 25 carbon atoms and at least one unsaturation;
n is 1 or 2; and
X is a metal cation.

6. A method of joining two rubber tyre portions, as claimed in claim 5, characterized in that said emulsifier has a CMC value of 0.1 to 2 mmol/L, and an HLB value of 21 to 45.

7. A method of joining two rubber tyre portions, as claimed in claim 6, characterized in that said emulsifier is sodium dodecylbenzenesulphonate or sodium lignosulphonate.

8. A method of joining two rubber tyre portions, as claimed in claim 1, characterized in that the adhesive compound contains 0.1 to 5 phr of said emulsifier.

9. A method of joining two rubber tyre portions, as claimed in claim 1, characterized by comprising an alkylphenol formaldehyde resin of the general formula:
R₁CONR₂CHR₃COOX
where:
R₁ is an aliphatic hydrocarbon group C₆-C₂₃;
R₂ is H or an aliphatic hydrocarbon group C₁-C₈;
R₃ is H or an aliphatic or aromatic hydrocarbon group C₁-C₈; and
X is a cation.

10. A method of joining two rubber tyre portions, as claimed in claim 9, characterized in that the alkylphenol making up the resin is p-phenol-2-pentyl-2,4,4-trimethyl.
